(19) United States
(12) Patent Application Publication
(10) Pub. No.: US 2006/0082062 A1
(43) Pub. Date: Apr. 20, 2006

(54) Card game

(76) Inventors: Russell P. Caterinicchio, Westminster, CO (US); William C. Peace, Broomfield, CO (US)

Correspondence Address: LITMAN LAW OFFICES, LTD, PO BOX 15035, CRYSTAL CITY STATION, ARLINGTON, VA, 22215, US

(21) Appl. No.: 11/144,746

(22) Filed: Jun. 6, 2005

Related U.S. Application Data
(63) Continuation of application No. 11/005,241, filed on Dec. 7, 2004.
(60) Provisional application No. 60/619,206, filed on Oct. 15, 2004.

(51) Int. Cl. A63F 9/24; G06F 19/00; A63F 3/08; A63F 1/00

(52) U.S. Cl. 273/274; 273/292; 273/303; 463/13; 463/27

(57) ABSTRACT

The card game provides for a series of three progressive wagers by players on three levels. After first wagers are placed, three cards are dealt face up to each player. Players may raise at this point, before a single dealer card is dealt. The object is for the player to have at least one of his/her three cards be of the same suit and of higher rank than the single dealer card. The game ends for unsuccessful players at this point. Successful players win their first progressive wagers and may place second progressive wagers to receive a fourth card. If the fourth card wins, the successful player may place a third progressive wager to receive a fifth card, with the same rules applying. Additional payouts may be provided for multiple cards meeting the rule and for various combinations of poker hands formed when all five player cards are dealt.

### CROSS REFERENCE TO RELATED PATENT APPLICATIONS

This application is a continuation in part of U.S. patent application Ser. No. 11/005,241 filed on Dec. 7, 2004, which application claims the benefit of U.S. Provisional Patent Application Ser. No. 60/619,206 filed on Oct. 15, 2004.

### BACKGROUND OF THE INVENTION

1. Field of the Invention

The present invention relates generally to wagering games. More particularly, the present invention comprises various embodiments of a card game in which players place progressive wagers on a series of cards in three tiers. The object is to have at least one card in the first tier, which matches the suit and is higher in rank than the single dealer card. Additional wagers involve cards above the first tier and may optionally include poker card combinations, etc.

2. Description of the Related Art

Wagering games using various playing card formats have been known for centuries. Many of these games have been incorporated into commercial gambling houses and casinos, where they are enjoyed by players from virtually all walks of life. These various wagering card games range from those having relatively simple rules (e.g., baccarat) to more complex games, such as certain forms of poker and other games that are seldom played at the casino level (e.g., bridge, cribbage, etc.).

Nearly all such games are based upon the principle of comparing a series of cards dealt randomly to the player(s) to a series of cards dealt randomly to the dealer or house, or to those cards of other players. Most such games involve a comparison of various card combinations held by the players or the house (e.g., poker), or a comparison of the count or rank of the cards held by the players and dealer or house (e.g., baccarat, blackjack, etc.). The present inventors are aware of one game in which the dealer draws only a single card, but players do not receive cards in this game. Rather, they place wagers relating to the suit and rank of the card, before the card is shown. The various types of card games noted above tend to be relatively complex, requiring an inordinate amount of time to learn to play well, or have relatively simple rules which result in a boring game after a relatively short time. Thus, a card game solving the aforementioned problems is desired.

### SUMMARY OF THE INVENTION

The card game provides a three-level progressive wager opportunity for players in a relatively uncomplicated game. Players place a first wager or ante before an initial series of three cards are dealt face up to each player. Players then have the opportunity to review their cards, and the cards of the other players, and may raise their initial wager at this time if so desired. At this point, a single card is dealt face up to the dealer. The object of the game is for the player(s) to have at least one of their three cards be of the same suit and of higher rank than the single dealer card. If this does not occur, the player is out of that hand of the game and no further cards are dealt to that losing player.

However, if the player does have at least one (or more) of the initial three cards which is/are of the same suit and higher in rank than the single dealer card, the player wins the first wager (and any raise he or she previously placed) and may place another progressive wager to receive a fourth card. The same basic rule applies to the new fourth card, as well. If the player's fourth card does not win, the game is over for that player and no further wagering opportunities are permitted for that player in that hand. However, if the player's fourth card is of the same suit and higher in rank than the single dealer card, the player wins the fourth card wager and may place a fifth card progressive wager and be dealt a fifth card. The same basic rule applies to a win or loss for the fifth and final card. Additional wagers may be placed upon other potential outcomes, including multiple winning cards and five-card poker hand combinations, at the discretion of the controlling establishment and/or governing body. Payouts are progressively higher for less likely outcomes, e.g., multiple winning cards in a player hand and/or certain less frequent poker combinations.

These and other features of the present invention will become readily apparent upon further review of the following specification and drawings.

### BRIEF DESCRIPTION OF THE DRAWINGS

FIG. 1 is a top plan view of a wagering table configured for the card game of the present invention, showing its general features.

FIG. 2 is a top plan view of two exemplary player positions for the card game of the present invention, showing a first tier card winning hand on the right side.

FIG. 3 is a top plan view of a pair of player positions, showing a first tier win and a pair forming a potential poker hand on the right side.

FIG. 4 is a top plan view of a pair of player positions, showing a two tier winning hand on the right side.

FIG. 5 is a top plan view of a pair of player positions in which the right player has won all three tiers of progressive wagers, and the left side player has a flush for the poker hand.

FIG. 6 is a top plan view of a pair of player positions in which the left side player has three of a kind in the first tier of cards.

FIG. 7 is a top plan view of a pair of player positions in which the left side player has four of a kind in the first two tiers of the hand.

FIG. 8 is a top plan view of a pair of player positions, showing a five card winning hand and flush poker hand on the left side.

FIG. 9 is a top plan view of a pair of player positions in which the left side player has a straight flush for the winning poker hand.

FIG. 10 is a top plan view of a pair of player positions in which the left side player has a royal flush for the winning poker hand.

FIG. 11 is a perspective view of an exemplary electronic video machine for the play of the present game.

FIG. 12 is a schematic diagram of an exemplary interactive electronic game system for the present card game invention.

FIG. 13 is a perspective view of a game card for the present card game, with the card having a peel-off concealing cover for the card hand.

FIG. 14 is a perspective view of a game card for the present card game, with the card having a scratch-off concealing cover for the card hand.

FIG. 15 is a flow chart illustrating the general steps in the method of play of the present game.

Similar reference characters denote corresponding features consistently throughout the attached drawings.

### DETAILED DESCRIPTION OF THE PREFERRED EMBODIMENTS

The present invention comprises various embodiments of a card game in which a variable number of player cards are compared with a single dealer card. The game is played using at least one deck (and preferably multiple decks) of conventional playing cards comprising four suits of thirteen cards each, ranging from a low card of a two through a high card of an ace. A player win occurs when at least one of the player's initial three cards: (a) is of the same suit as the single dealer card, and (b) is of a higher rank than the single dealer card. Additional levels provide the opportunity for additional wins by the player, if that player wins the initial three-card hand by having at least one card that meets the requirement. Other embodiments may provide for the play of poker-like hands with two additional cards, and/or wagering on the various card combinations of the present game. The present game may be played as a private game, either with or without wagers involved, or as a casino type game where wagering is a part of the game.

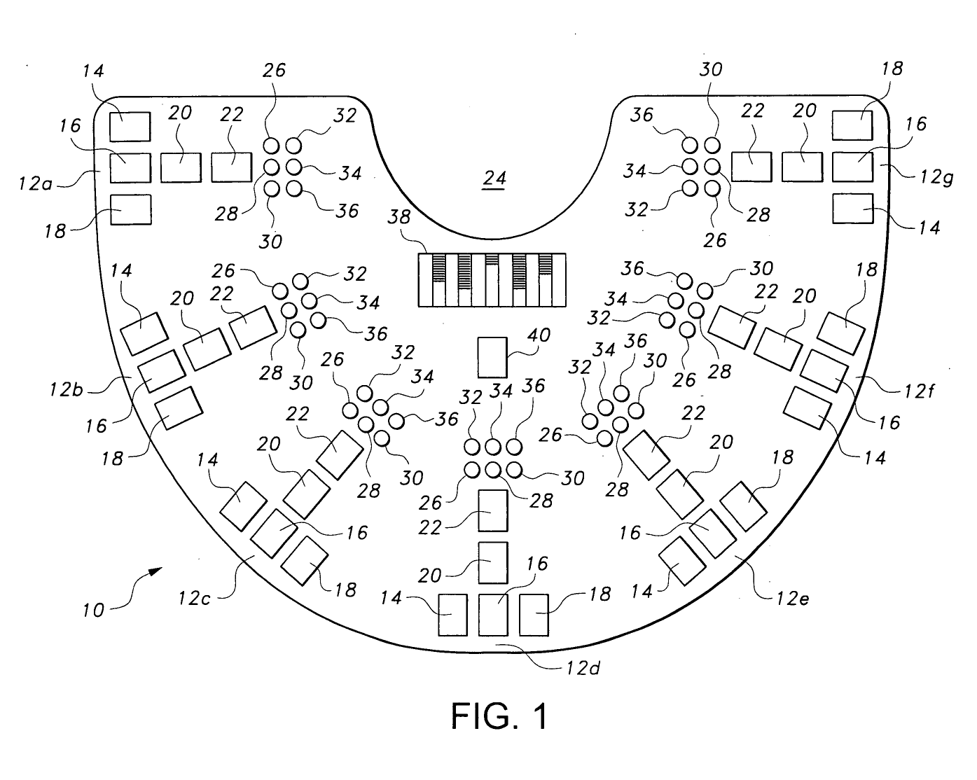

FIG. 1 of the drawings illustrates an exemplary table layout for the play of the present card game as a casino game. In FIG. 1, the table 10 includes playing positions 12a through 12g for seven players, but it will be seen that more or fewer player positions may be provided as desired. Each player position 12a through 12g includes a series of five card positions in the form of an inverted T when viewed from the orientation of each of the players. The first three card positions 14 through 18 form the crossbar of the T and are called the “reverse phalanx.” The fourth and fifth card positions 20 and 22 form the stem of the T and are oriented toward the dealer position 24. Each player has a series of three progressive wagering positions 26 through 30, with a similar series of three progressive payoff positions 32 through 36 directly opposite the player wagering positions 26 through 30. The dealer also controls a house supply of chips 38 and has a single dealer card position 40.

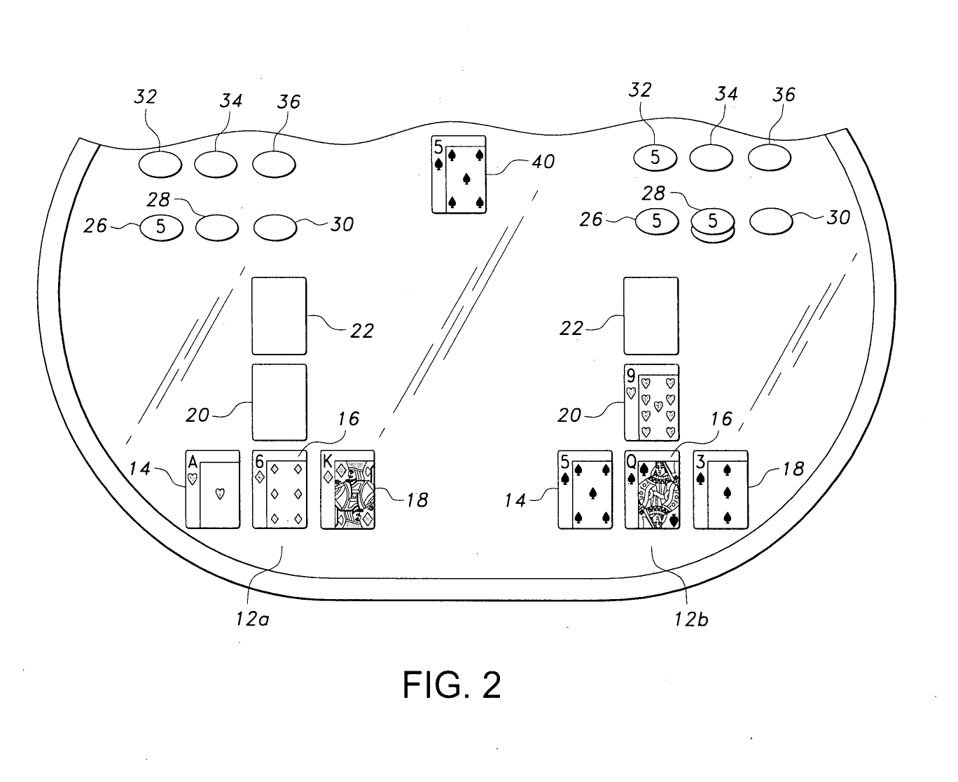

FIGS. 2 through 10 illustrate two exemplary player positions 12a and 12b. It will be understood that additional positions may be included on the table, as in the exemplary seven-position table of FIG. 1. Only two positions 12a and 12b are illustrated in FIGS. 2 through 10, for simplicity and clarity in the drawing Figs. Each position 12a and 12b includes the five card positions 14 through 22 and the three player progressive wager positions 26 through 30 and corresponding dealer payout positions 32 through 36, along with the single dealer card position 40.

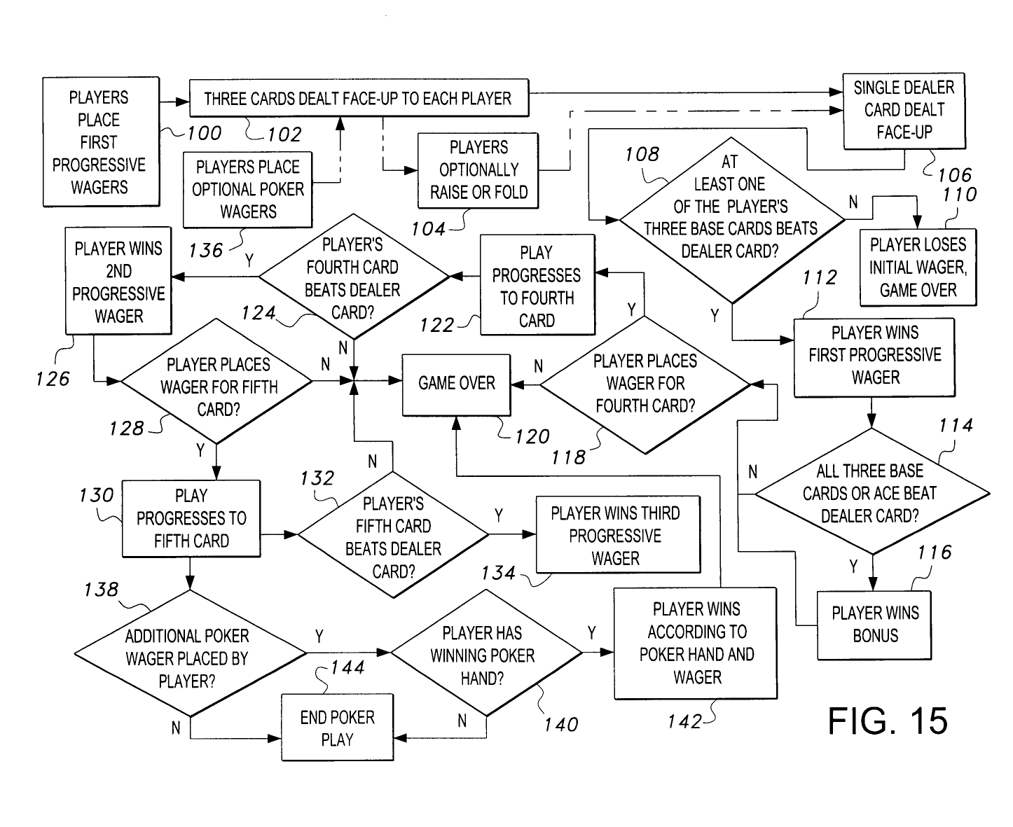

The game is begun when each player places an initial progressive wager on their first progressive wager position 26, as shown in FIG. 2 and described generally in the first step 100 of the flow chart of FIG. 15. It will be understood that FIGS. 2 through 10 illustrate subsequent steps in the game as well, and may show additional progressive wagers and card play over and above this first step 100.

Once the wagers have been placed, the dealer deals a series of three cards face up to each player on the respective first through third positions 14 through 18 forming the crossbar or “reverse phalanx” of the card pattern for each player, generally as described in the second step 102 of the flow chart of FIG. 15. At this point, the players can of course observe their cards, as well as the cards of other players. This enables the players to form some judgment as to the likelihood of their being able to beat the single dealer card (yet to be played and shown). For example, a player with a three card hand as shown in the first player position 12a of FIG. 2, has a reasonable chance of beating the yet unplayed single dealer card, as two of the three cards are high ranking and of two different suits. The player may choose to raise his or her initial ante with such a hand, which is permitted at this point in accordance with the optional third step 104 of FIG. 15. (As can be seen, none of the first player's cards match the suit of the single dealer card in this example, but the player has not yet seen the single dealer card at this point in the game and thus must gamble on the potential outcome.)

On the other hand, the second player position 12b has been dealt three initial cards all of the same suit, with one relatively high-ranking card. While the high ranking card would likely beat most dealer cards, with only a single high ranking card and with all cards being of the same suit, the odds of any of the second player position 12b initial cards beating the (as yet unknown) dealer card, are relatively low. In such a situation the player may fold and drop out of the game, which option is permitted in accordance with the optional third step 102 of FIG. 15. However, the player may as well remain in the game in order to see the forthcoming single dealer card; no further ante or raise is required at this point for the player to see the dealer card, and there is still some small chance of a win by the player. Another reason for staying in, is that the three identically suited cards may form the beginning of a flush poker hand. While the awarding of payouts for poker hand combinations is not a requirement of the present game, it is an option that may be permitted in certain games by certain gambling houses and casinos, in accordance with their rules and/or gaming commission rules.

Some judgment is called for here also, when casino rules provide payouts only to the best player hand or relatively few top hands. A player may note that another player(s) has or have (a) potentially superior hand(s), and decide that even if he or she has one or more cards which beat the forthcoming single dealer card, that there is little or no chance of their hand being the top hand or one of the top hands and receiving a payout. Again, this depends upon the rules of the gaming establishment and/or gaming commission. In many, if not most, cases, it is anticipated that the house will provide payouts to all hands that contain at least one card that beats the single dealer card, but this is not mandatory per the rules of the present disclosure.

Once each player has received his or her initial baseline of three cards, and players choosing to raise or fold have done so, the dealer plays a single card face up on the dealer card position 40, as indicated by the fourth step 106 of FIG. 15. The remaining fourth and fifth player card positions 20 and 22 remain open at this point in the game.

At this point in the game, the first three cards dealt to each player are compared to the single dealer card, generally as indicated in the fifth step 108 of the flow chart of FIG. 15. In order for a player to win his/her initial wager, i.e., the wager placed upon the first bettor position 26, one of the three cards on one of the three crossbar or “reverse phalanx” positions 12 through 18 must be of (a) the same suit as the single dealer card, and (b) a higher rank than the single dealer card. In the example shown in FIG. 2, the single dealer card is the five of spades. This provides players with relatively good odds, as there are only three cards in each suit that rank below the five. The odds of a player drawing at least one of three cards which is of (a) the same suit as the dealer card and (b) a higher rank than the dealer card are relatively high, with nine cards remaining in a standard fifty two card deck which are of the same suit and of a higher rank than the five of spades.

In FIG. 2, the first player position 12a has no cards in the first three card baseline of positions 14 through 18 which beat the dealer's five of spades, as all of the position 12a cards are of different suits than the dealer card. This player 12a would lose his or her initial bet with no further wagers being permitted by that player for the remainder of that hand, as indicated by the sixth step 110 of the flow chart of FIG. 15. However, player position 12b of FIG. 2 includes three spades in the three card baseline with one of those cards (i.e., the queen of spades of the center position 16) being of higher rank than the single dealer card, entitling that player to receive a payoff for his or her initial wager, as indicated by the payout chip in the position 32 for player 12b in FIG. 2, as well as by the seventh step 112 of the flow chart of FIG. 15.

The present card game may also provide for bonus payouts for certain less common card combinations or outcomes. For example, if all three of a player's first three cards match the suit of the single dealer card and outrank the dealer card, as provided in the eighth step 114 of FIG. 15, that player may win a bonus, as indicated by the bonus payout step 116 of FIG. 15. The player 12b may also be paid a bonus for having all three cards match the suit of the dealer's card, as well, even though only one (the queen of spades on the second position 16) outranks the dealer card. Such a bonus is at the discretion of the house rules. In any case, the player is allowed to progress to the next tier of play, providing that player has at least one winning card in the three baseline cards. Bonuses may also be paid to players having their fourth and/or fifth cards, where received, beat the dealer's card as well.

At this point, the player must determine whether or not he or she wishes to continue to play the hand. The player has the option of refusing to place another progressive wager, as indicated by the tenth step 118 of FIG. 15, in which case that player is out of the game for the remaining duration of the hand, as indicated by the eleventh step 120 of FIG. 15. However, if the first tier winning player places a second tier progressive wager, as provided by the tenth step 118, then play progresses to a fourth card which is played on the fourth position 20 for participating players, as indicated by the twelfth step 122 of FIG. 15.

A review of FIG. 2 shows that the first player 12a cannot continue the game, as all of his or her baseline cards are of different suits than the single dealer card. Hence, the first player of position 12a has lost his or her initial progressive wager or ante on the position 26, with no further wagers being placed by that player and no payouts being made to that player. However, the second player of position 12b has decided to place a second tier progressive wager, as indicated by the second wager on the position 28 for that player and his or her receipt of a fourth card on the position 20. When this fourth card, i.e., the nine of hearts, is compared to the single dealer card, as provided in the thirteenth step 124 of FIG. 15, this fourth card is of a different suit and thus cannot beat the dealer card. The second player loses his or her second progressive wager on position 28 and the game is over for that player, as indicated by the eleventh step 120 of the flow chart of FIG. 15.

It will be seen in the exemplary hands of FIG. 2, that the turned up dealer card of the dealer position 40, i.e., the five of spades, exactly matches both the suit and rank of the first card of position 14 for the second player 12b. While this is not possible when using only a single deck of cards, it is quite possible when playing with two or more decks, as is standard procedure in most casino card games. When this occurs, it is considered a “push” or tie, with rules requiring the first wager on the first position 28 to be returned to the player, but permitting the player to continue play when he or she places a second tier progressive wager and receives a fourth card as shown for the position 12b of FIG. 2. (In the example of FIG. 2, the player would not actually have a “push” situation due to his or her winning card, i.e., the queen of spades, on the second card position 16.)

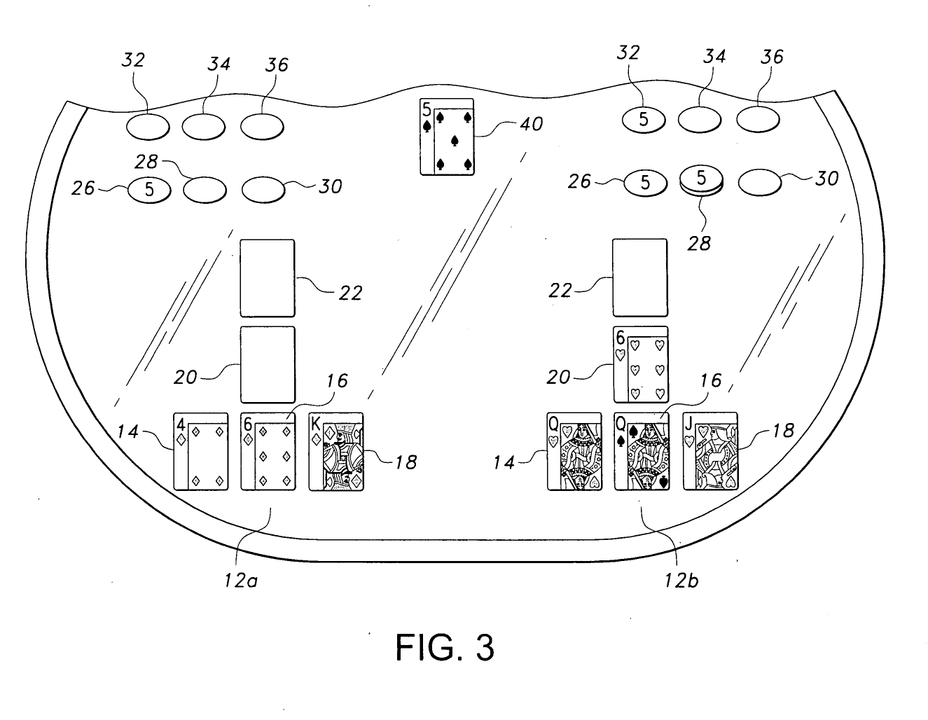

In FIG. 3, the first player has lost his or her initial progressive wager, as none of his or her three baseline cards match the suit of the single dealer card. However, the second player position displays the queen of hearts on the first card position 14 and the queen of spades on the second card position 16. As the second player position contains one card which beats the dealer card, i.e., the player's queen of spades beats the dealer's five of spades, the second player position 12b wins the initial or base line wager and may receive an additional card after placing a second tier progressive wager, i.e., the six of hearts on the card position 20. This additional card does not add to the value of the hand, but the two queens of the three baseline cards may be considered to form a pair of queens as an optional poker hand, depending upon the supplemental rules of play of the casino or gaming establishment. In some cases it may be required that players progress through all three tiers of progressive wagers and win the first and second tiers in order to receive a third tier card, thus filling out a five card hand. In other cases this may be considered restrictive, as many poker hand combinations (e.g., pairs, three of a kind, four of a kind) do not require all five cards. Under those circumstances, FIG. 3 illustrates a potential poker hand comprising a pair of queens, although the flow chart of FIG. 15 is arranged to indicate that players must progress to receive all three tiers of cards, i.e., five cards total, in order to be eligible for optional poker hand play.

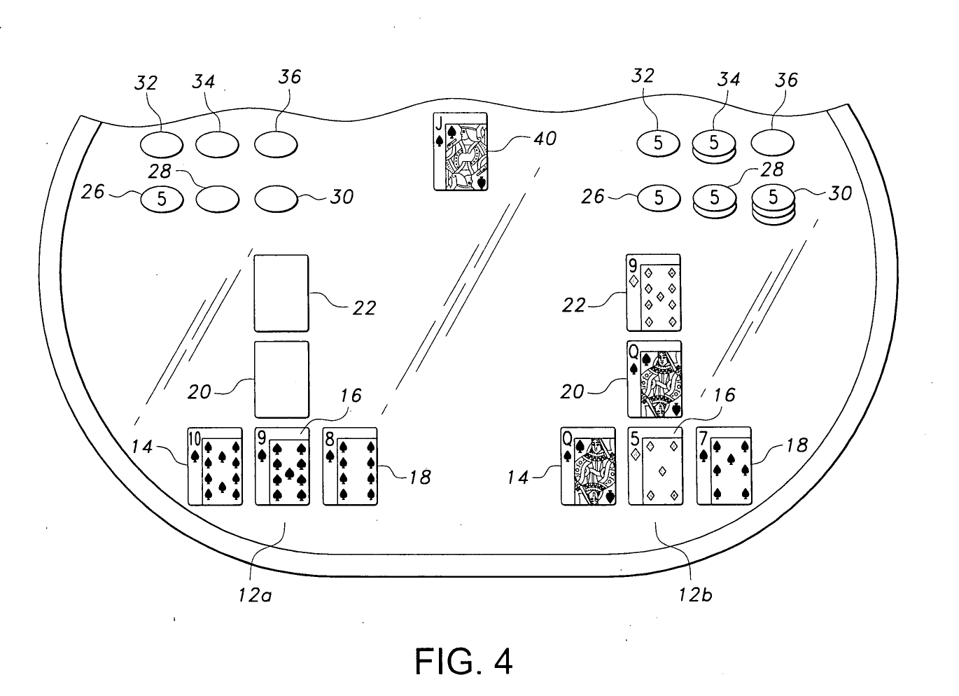

FIG. 4 of the drawings illustrates another exemplary card combination that may occur in the play of the present card game. In FIG. 4, it will be seen that for the player position 12a, although all of the first three cards of the positions 14 through 18 are of the same suit as the single dealer card, i.e., spades, none of that player's first three cards are of higher rank than the jack of spades dealt to the dealer position 40. While the odds of at least one of the first three player cards matching the suit of the dealer card are constant, the higher the rank of the card dealt to the single dealer position 40, the less likely it will be that any of the first three cards dealt to each player will at least match or exceed the rank of the single dealer card in order for the player to continue to the next level of play. Thus, the first player 12a in FIG. 3 has lost his/her first wager, in accordance with the sixth step 110 of the flow chart of FIG. 15.

However, a review of the right side hand 12b of FIG. 4 shows that the first card position 14 contains the queen of spades, which qualifies as a winning card in that it is of the same suit and of a higher rank than the jack of spades dealer card in FIG. 4. This entitles the player at the second player position 12b to place a second tier progressive wager and receive a fourth card along the stem of the T card pattern to form a four card hand, as indicated by the twelfth step 122 of the flow chart of FIG. 15. When a player receives a fourth card after winning or tying with one of the first three cards, the fourth card is compared sequentially to the dealer card in the same manner as the first three base cards of the positions 14 through 18. In the case of the second position 12b of FIG. 4, the fourth card is the queen of spades, which beats the jack of spades dealer card. This enables the player to win his second progressive bet, as indicated by the matching quantity of chips placed on the second progressive dealer bet position 34 for the second player position 12b in FIG. 4. This fourth card wager, comparison and win is indicated by the tenth, twelfth, thirteenth and fourteenth steps 118, 122, 124 and 126 of the flow chart of FIG. 15. In the case of a “push” or tie between the fourth card and dealer card, the second progressive wager is returned to the player, just as in the case of a “push” in the first three cards, as discussed further above. The player still continues on to the fifth and final card.

As the second player 12b of FIG. 4 has won the second tier wager, he or she is eligible to place a third tier wager and receive a fifth card, as indicated by the fifteenth and sixteenth steps 128 and 130 of FIG. 15. Further review of the fifth card position 22 of the second player position 12b of FIG. 4 shows that this position contains the nine of diamonds. As this card is not of the same suit and higher rank than the jack of spades dealer card, the player at position 12b loses his/her wager for the fifth card, as indicated by the loss of wager chips on the third progressive wager position 30 for the player of position 12b in FIG. 4 and the seventeenth step 132 and eleventh (“Game Over”) step 120 of the flow chart of FIG. 15. In the event of a winning fifth card, the player wins his or her third progressive wager, as indicated by the eighteenth step 134 of FIG. 15. A “push” between the final fifth card and dealer card results in the player's third progressive wager being returned to the player, just as in the cases of “push” situations in the first two levels of play, as may occur when multiple decks are used.

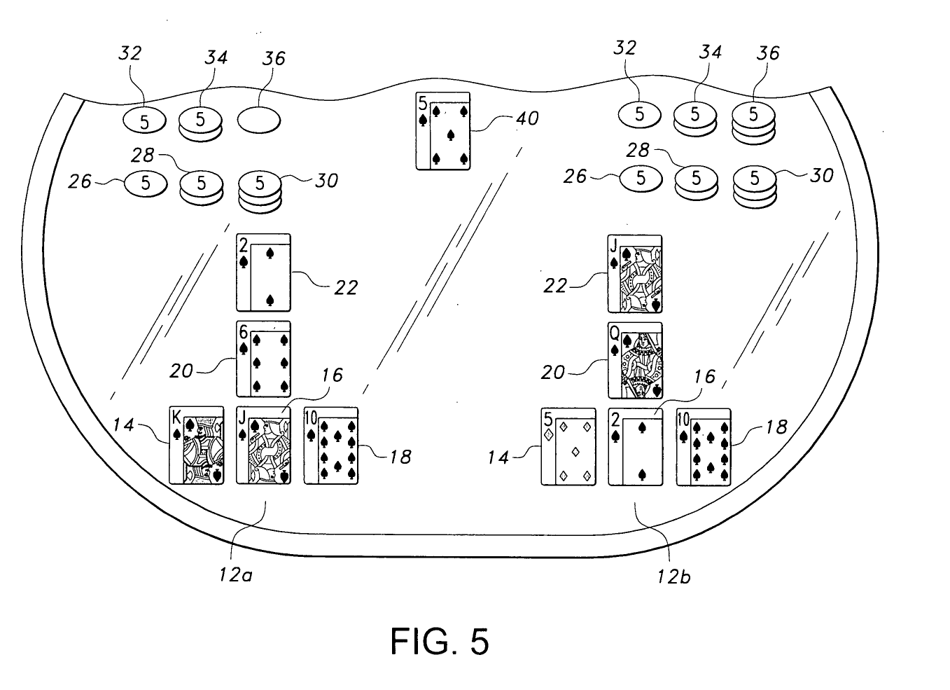

FIG. 5 illustrates a five-card flush poker hand in the left player position or hand 12a. Optional poker play may occur in the present game in accordance with any house and/or gaming commission rules permitting such. In order to participate in such optional poker play, players must place an optional poker wager, as indicated by the optional nineteenth step 136 of the flow chart of FIG. 15. It will be seen that each of the first three cards in positions 14 through 18 beat the single dealer card in the hand 12a, allowing that player to win a bonus equal to all three progressive wagers with the first three cards, in accordance with steps 114 and 116 of the chart of FIG. 15. In addition, the player has received a winning fourth card and continued play to receive a fifth card to form a five-card poker hand. The fourth and fifth cards are also spades and complete the five card flush poker hand of the first playing position 12a in FIG. 5. Assuming that the player has placed an optional poker bet per the nineteenth and twentieth steps 136 and 138 of FIG. 15, the hand may be considered as a poker hand. If the player has a winning poker hand, e.g., the hand of player 12a in comparison to the hand of player 12b in FIG. 5, then that player wins the poker hand in accordance with the twenty-first and twenty-second steps 140 and 142 of FIG. 15. If the player has not placed an optional poker wager, or does not have a winning poker hand, poker play is ended for that player in accordance with the twenty-third step 144 of the flow chart of FIG. 15.

It will be noted that any flush poker hand formed according to the present card game, must be of the same suit as the dealer card. Even if the first three cards drawn are of the same suit, if they are of a different suit than the single dealer card, they cannot possibly win the first progressive wager to allow the player continue playing the hand by receiving additional cards to play the second and third progressive wagers and to form a five card poker hand. It will also be noted in FIG. 5 that the hand of the second player position 12b is also a winning hand, even though not a winning poker hand. The second player has received the ten of spades for his/her third card of the base “reverse phalanx” row, winning the initial progressive wager and entitling that player to place a wager for a fourth card. The fourth card is the queen of spades, which beats the dealer's five of spades to win the second progressive wager even though the hand is not a winning poker hand. The player has gone on to place a third progressive wager and draw a fifth card, i.e., the jack of spades, which also beats the five of spades dealer card.

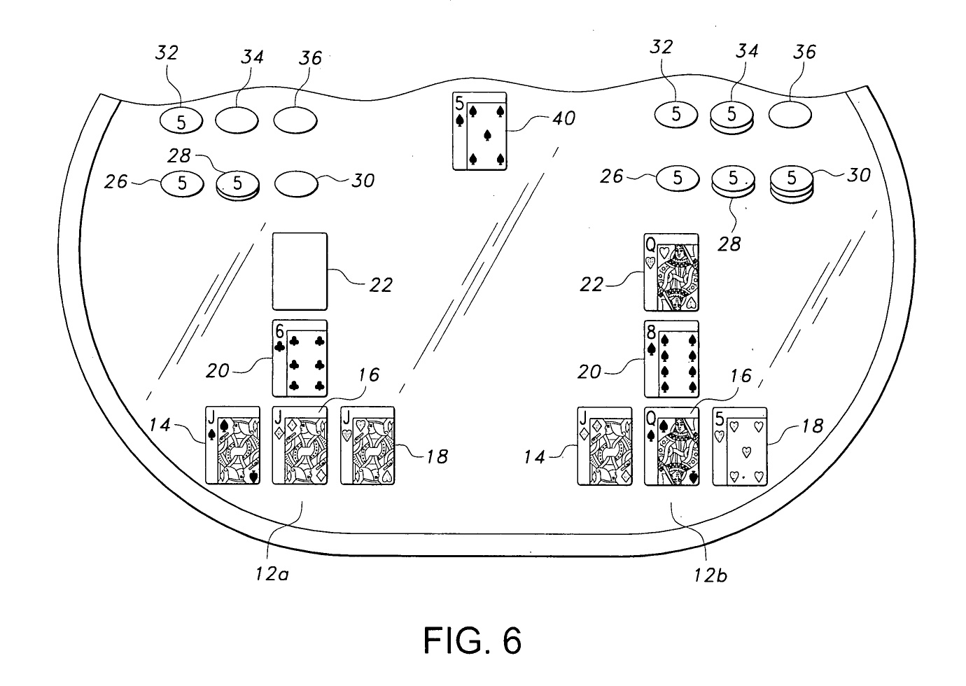

FIG. 6 illustrates yet another poker combination in which the first player position 12a comprises a three of a kind poker hand having three jacks in the first or baseline tier. The first jack of the first card position 14 beats the dealer card of the same suit, allowing the player to place another progressive wager and receive a fourth card. The fourth card is of a different suit (clubs) than the dealer card (spades), and thus loses the second progressive bet. Such a three of a kind hand would form a good foundation for a potential full house, i.e., three of a kind and a pair, if the fourth card were of the same suit and higher in rank than the dealer card to allow the player to place a third progressive wager and draw a fifth card. However, as noted further above the rules may be adjusted to allow poker hand combinations containing fewer than five cards to be considered as winning hands, if so desired. It will be noted that the hand of the second player position 12b also contains a single winner in the base row, as well as a winning fourth card to win the second progressive wager. However, the pair of queens in the second player hand loses to the three of a kind of the first player hand, if the players have placed optional poker bets and poker combinations of fewer than five cards are permitted.

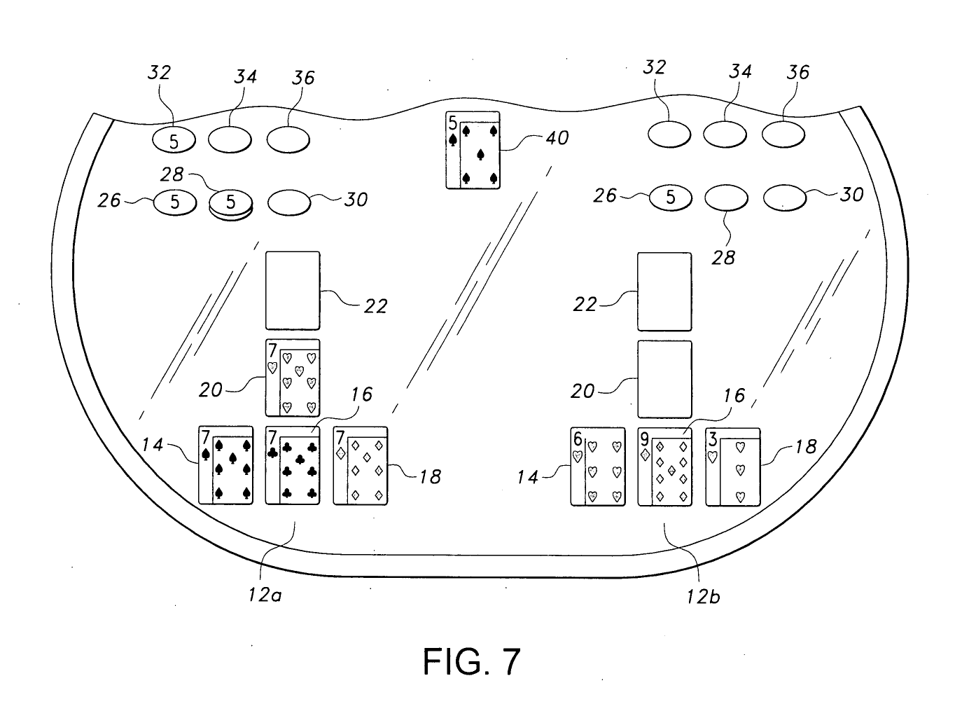

FIG. 7 illustrates a poker hand containing four of a kind in the first player position 12a. In FIG. 7, the first player has received the seven of spades in the first card position 14, and two more sevens of different suits for his/her second and third cards. The seven of spades wins over the five of spades dealer card, winning the initial progressive wager and allowing the player to place a second progressive wager and receive a fourth card on card position 20. The fourth card is also a seven, but of a different suit (hearts) than the dealer card (spades). Thus, the player of position 12a is ineligible to place a third progressive wager and draw a fifth card. Nevertheless, if the first player 12a has placed an optional poker wager, and rules permit poker combinations of fewer than five cards, the four of a kind poker hand of the first position 12a in FIG. 7 would almost certainly win against any other poker hands likely to be drawn by other players, thus providing the first player with an alternative means to win the hand other than the three level progressive wager of the basic game.

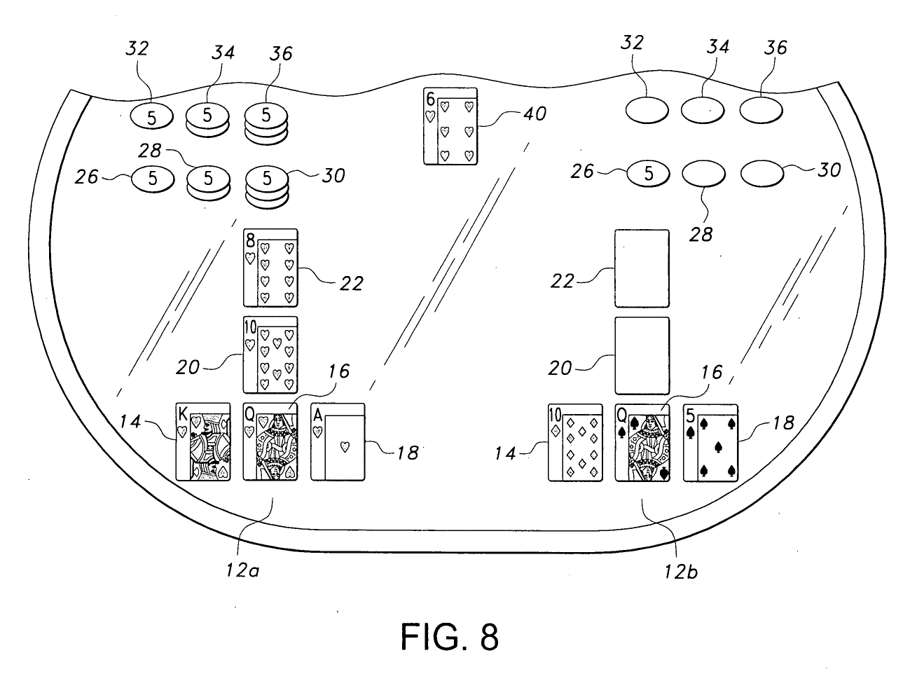

FIG. 8 provides an illustration of yet another possible hand in the present game, in which a player may receive five of five cards that beat the dealer's single card. Such a hand is illustrated in the first player position 12a of FIG. 8. In FIG. 8, the player has been dealt the king, queen, and ace of hearts for the first three cards, all of which beat the six of hearts of the dealer's card. In addition, the player's fourth and fifth cards comprise the ten and eight of hearts, respectively, giving the player a total of five out of five cards which beat the single dealer card. Such an occurrence is a relatively rare event, with the payout provided accordingly. An exemplary payout may be at two hundred to one, with alternative odds and payouts being provided in accordance with the rules of the house and/or gaming commission as appropriate.

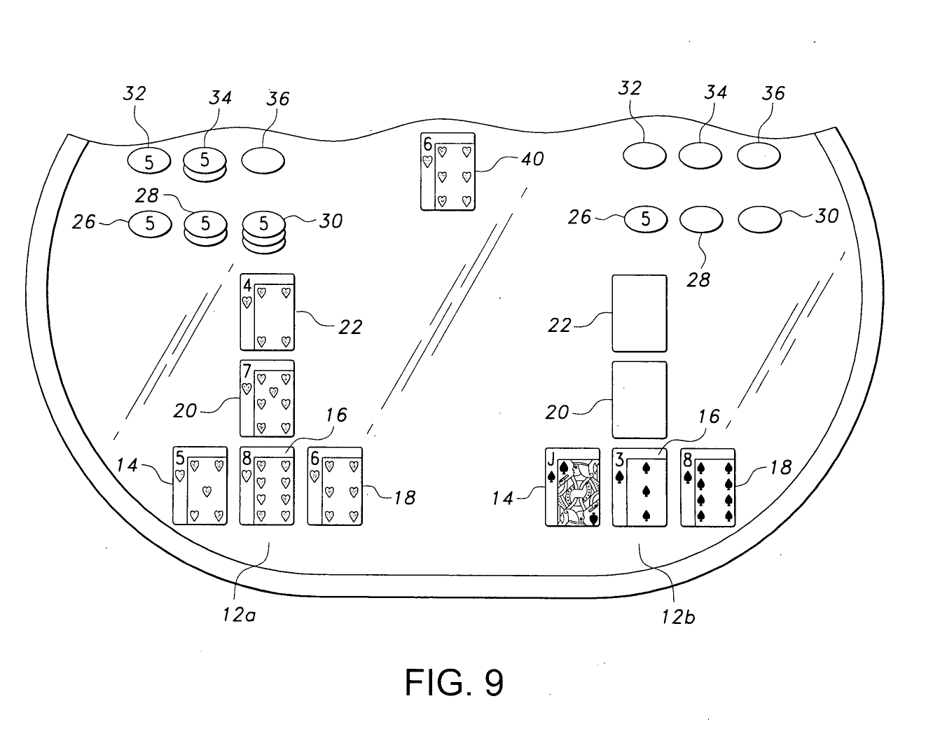

FIG. 9 includes a five-card hand of even higher poker rank, comprising a straight flush. In FIG. 9, the first three card positions 14 through 18 of the first hand position 12a have been dealt three hearts, with the eight of hearts being high and beating the six of hearts card of the dealer position 40. This has resulted in the player placing a second progressive wager and the addition of a fourth card to the hand, as well as winning the initial progressive wager. The fourth card is the seven of hearts, which not only wins the second progressive wager, but also fills in the gap between the six and eight of hearts in the first three cards to provide the possibility of a straight or straight flush, depending upon the fifth card. As the fourth card also beat the dealer's card, the player has the option of placing a third progressive wager and receiving a fifth card, as shown in the hand 12a of FIG. 9. The fifth card turns out to be the four of hearts, which while not beating the dealer's six of hearts, does complete the straight flush poker hand for the first player position 12a.

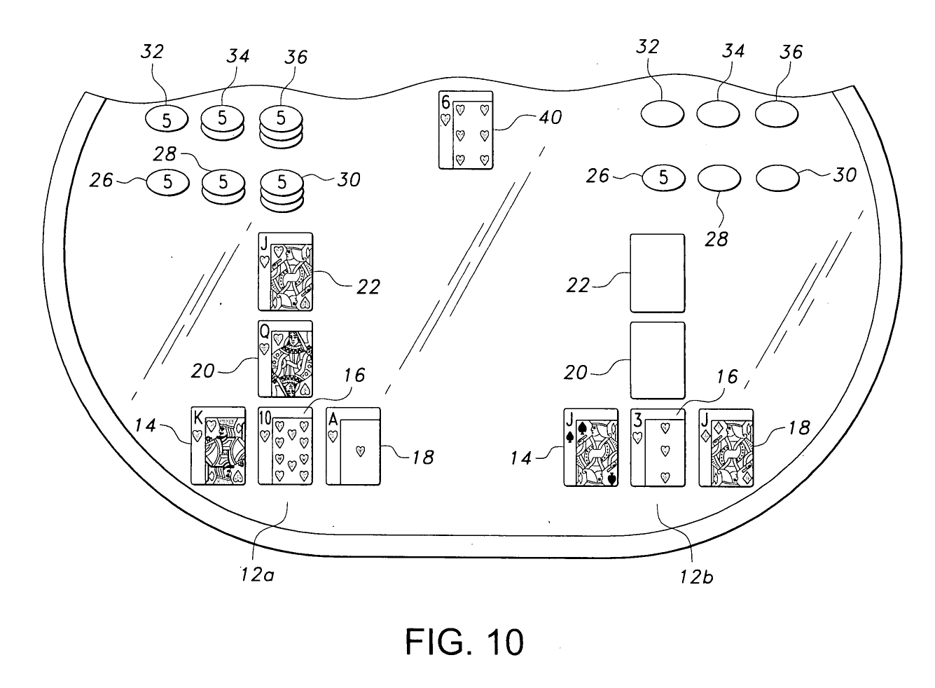

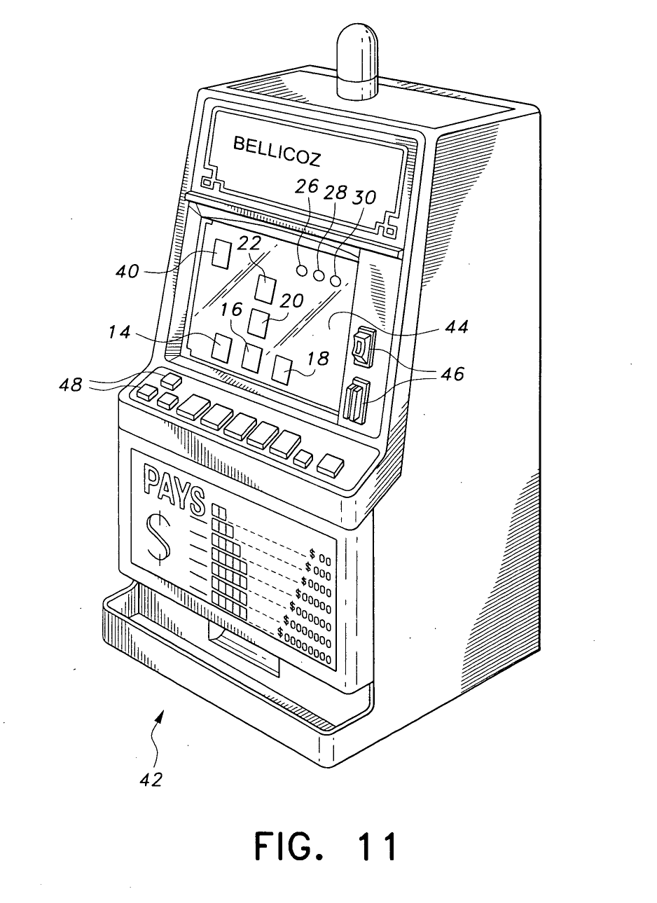

FIG. 10 illustrates a five-card poker type hand containing a royal flush. The only difference between a royal flush and a straight flush is that the royal flush contains cards ranking from ace through ten inclusive, thus containing the three “royal” face cards. This is the rarest, and thus highest ranking, of the poker hands. In the example of FIG. 10, the dealer has turned up the six of hearts on the dealer card position 40. The first player has drawn the king, ten, and ace of hearts for his/her first three cards, all of which beat the dealer's six of hearts to win the first tier wager and any bonus provided, in accordance with the seventh and eighth steps 112 and 114 of the flow chart of FIG. 15. In addition, the player is dealt a fourth card after choosing to place a second tier progressive wager, i.e., the queen of hearts, to continue the potential royal flush. This fourth card beats the dealer's card, thus allowing the player to place a third progressive wager and draw a fifth card. As can be seen in the first player position 12a of FIG. 10, the player has drawn the jack of hearts for his/her fifth card, thus completing the royal flush. A bonus payout of e.g., two hundred to one (or other odds, as desired) may be paid when all five of a player's cards beat the dealer card. Again, the payouts may be adjusted as desired or required according to the rules of the gambling establishment and/or gaming commission. A player receiving such a hand would certainly also win any poker wager which may have been placed by the player, in addition to the bonus payout noted above.

The present game is particularly well suited for casino play, but may be played in other environments as well. In addition, various types of video gambling machines may be programmed for play of the present game, if so desired. FIG. 20 provides an illustration of such an exemplary machine 42 having a screen 44 displaying the five card positions 14 through 22 used in the present game, as well as the three progressive player wagering points 26 through 30 and a single dealer card position 40. Coin or token acceptance slots 46 may also be provided, along with various controls 48 for the player.

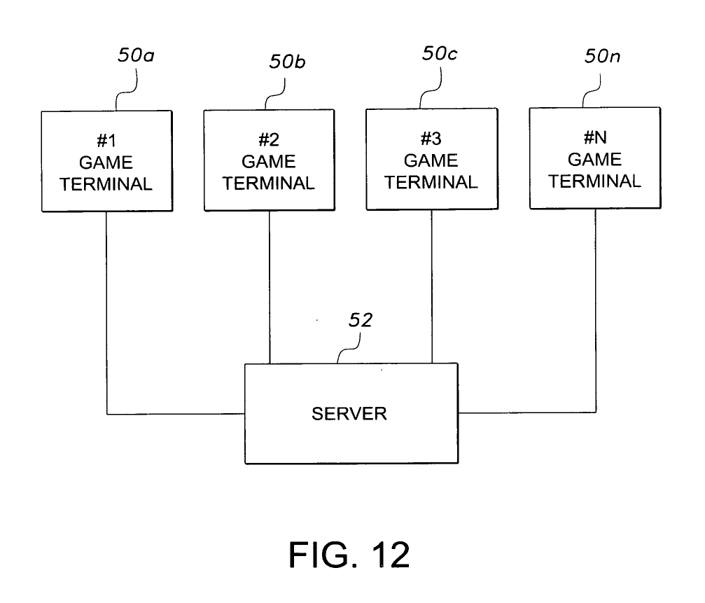

FIG. 12 provides an illustration of yet another electronic system for playing the present card game, in which a series of game terminals 50a, 50b, 50c, . . . 50n are all connected to a central server 52. Such a computer network is conventional, and may be programmed to allow a series of n players, each playing at one of the game terminals 50a through 50n, to play against a computerized dealer position (at the server 52) and against one another.

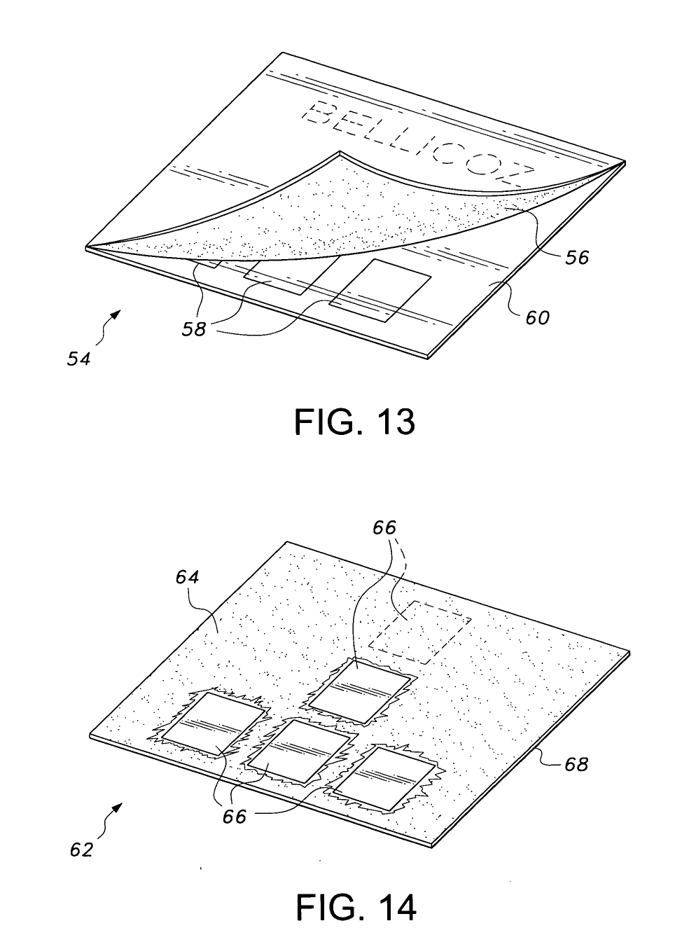

The present card game may also be played using lottery style cards in which the specific playing card representations are concealed until purchased and revealed by the purchaser. FIGS. 13 and 14 disclose such lottery style cards. In FIG. 13, a peel-off type lottery card 54 is shown, with the opaque peel-off backing 56 partially removed to reveal some of the playing card representations 58 on the backing sheet 60 thereunder. In FIG. 14, the lottery style card 62 is covered with an opaque coating 64 which may be selectively removed (“scratch off” type coating) to reveal the playing card representations 66 thereunder, disposed upon the underlying backing sheet 68. It will be seen that the present card game is adaptable to any of the above described playing media, as well as various others that may be adapted for use with the present game.

In conclusion, the present card game provides numerous interesting levels of play, with many of those levels building upon earlier levels to increase the enjoyment and excitement of playing the game. While the basic concept of the game is simple, i.e., drawing at least one card which matches the suit and beats the rank of the single dealer card, the various alternatives which may occur during play and which are available to the players result in a game which will hold the interest of players throughout the period of play. The provision of additional wagering for poker hands formed after a successful first level of play provides further interest and challenge to players. Accordingly, the present game will find great acceptance and interest by players and in casinos and other gambling establishments, both in its live dealer format as well as a video electronic version.

It is to be understood that the present invention is not limited to the embodiments described above, but encompasses any and all embodiments within the scope of the following claims.

We claim:

1. A method of playing a card game, comprising the steps of:
(a) placing a first progressive wager by each player;
(b) dealing an initial series of three cards face up to each player;
(c) dealing a single dealer card face up;
(d) comparing the three cards of each player to the single dealer card;
(e) paying a winning first progressive wager to each player having at least one card of the same suit and of higher rank than the single dealer card;
(f) collecting all wagers and the initial series of three cards from each player failing to have at least one card of the same suit and of higher or equal rank to the single dealer card;
(g) placing a second progressive wager as desired by each first progressive wager winning player;
(h) dealing a fourth card to each second progressive wager placing player;
(i) comparing the fourth card to the single dealer card;
(j) paying a winning second progressive wager to each player having a fourth card of the same suit and of higher rank than the single dealer card;
(k) collecting a losing second progressive wager from each player having a fourth card not of the same suit and of higher or equal rank to the single dealer card;
(l) placing a third progressive wager as desired by each second progressive wager winning player;
(m) dealing a fifth card to each third progressive wager placing player;
(n) comparing the fifth card to the single dealer card;
(o) paying a winning third progressive wager to each player having a fifth card of the same suit and of higher rank than the single dealer card; and
(p) collecting a losing third progressive wager from each player having a fifth card not of the same suit and of higher or equal rank to the single dealer card.

2. The method of playing a card game according to claim 1, further including the step of optionally raising the first progressive wager by each player as desired, after receiving the initial series of three cards and before dealing the single dealer card.

3. The method of playing a card game according to claim 1, further including the steps of:
(a) returning the first progressive wager to each player having at least one of the initial series of three cards of the same suit and equaling the rank of the single dealer card;
(b) returning the second progressive wager to each player having the fourth card of the same suit and equaling the rank of the single dealer card; and
(c) returning the third progressive wager to each player having the fifth card of the same suit and equaling the rank of the single dealer card.

4. The method of playing a card game according to claim 1, further including the step of paying a bonus wager to each player having all of the initial series of three cards of the same suit and of higher rank than the single dealer card.

5. The method of playing a card game according to claim 1, further including the step of paying a bonus wager to each player having all of the initial series of three cards and one of the fourth and fifth cards of the same suit and of higher rank than the single dealer card.

6. The method of playing a card game according to claim 1, further including the step of paying a bonus wager to each player having all of the initial series of three cards and the fourth and fifth cards all of the same suit and of higher rank than the single dealer card.

7. The method of playing a card game according to claim 1, further including the steps of:
(a) placing at least one poker wager by at least one player;
(b) dealing a fourth card to each player winning their first progressive wagers and placing a second progressive wager, and a fifth card to each player winning their second progressive wagers and placing a third progressive wager;
(c) considering the initial series of three cards along with the fourth card and fifth card as a five-card poker hand;
(d) paying a winning poker wager to the at least one player placing at least one poker wager and having a winning poker hand; and
(e) collecting a losing poker wager by the at least one player placing at least one poker wager and having a losing poker hand.

8. The method of playing a card game according to claim 1, further including the step of using multiple card decks for the play of the card game.

9. A method of playing a card game, comprising the steps of:
(a) dealing an initial series of three cards face up to each player;
(b) dealing a single dealer card face up;
(c) comparing the three cards of each player to the single dealer card;
(d) designating the initial series of three cards as a winning hand when at least one of the three cards is of the same suit and of higher rank than the single dealer card; and
(e) designating the initial series of three cards as a losing hand when none of the three cards are of the same suit and of higher rank than the single dealer card.

10. The method of playing a card game according to claim 9, further including the steps of:
(a) placing at least one wager by each player before dealing any of the cards;
(b) paying a winning first wager to each player having a winning hand; and
(c) collecting all wagers and the initial series of three cards from each player having a losing hand.

11. The method of playing a card game according to claim 10, further including the step of optionally raising the first progressive wager by each player as desired, after receiving the initial series of three cards and before dealing the single dealer card.

12. The method of playing a card game according to claim 10, further including the step of paying a bonus wager to each player having all of the initial series of three cards of the same suit and of higher rank than the single dealer card.

13. The method of playing a card game according to claim 10, further including the step of returning the first wager to each player having at least one of the initial series of three cards of the same suit and equaling the rank of the single dealer card.

14. The method of playing a card game according to claim 9, further including the steps of:
(a) dealing a fourth card to each player having at least one card of the same suit and of higher or equal rank than the single dealer card;
(b) comparing the fourth card to the single dealer card;
(c) designating the fourth card as a winning card when the fourth card is of the same suit and of higher rank than the single dealer card;
(d) designating the fourth card as a losing card when the fourth card is of not the same suit and of higher rank than the single dealer card;
(e) dealing a fifth card to each player having the fourth card of the same suit and of higher or equal rank than the single dealer card;
(f) comparing the fifth card to the single dealer card;
(g) designating the fifth card as a winning card when the fifth card is of the same suit and of higher rank than the single dealer card; and
(h) designating the fifth card as a losing card when the fifth card is of not the same suit and of higher rank than the single dealer card.

15. The method of playing a card game according to claim 14, further including the steps of:
(a) placing a first progressive wager by each player before dealing any of the cards;
(b) paying a winning first progressive wager to each player having a winning hand;
(c) collecting all wagers and the initial series of three cards from each player having a losing hand;
(d) placing a second progressive wager as desired by each first progressive wager winning player;
(e) paying a winning second progressive wager to each player having a fourth card of the same suit and of higher rank than the single dealer card;
(f) collecting a losing second progressive wager from each player having a fourth card not of the same suit and of higher or equal rank to the single dealer card;
(g) placing a third progressive wager as desired by each second progressive wager winning player;
(h) paying a winning third progressive wager to each player having a fifth card of the same suit and of higher rank than the single dealer card; and
(i) collecting a losing third progressive wager from each player having a fifth card not of the same suit and of higher or equal rank to the single dealer card.

16. The method of playing a card game according to claim 15, further including the step of paying a bonus wager to each player having all of the initial series of three cards and one of the fourth and fifth cards of the same suit and of higher rank than the single dealer card.

17. The method of playing a card game according to claim 15, further including the step of paying a bonus wager to each player having all of the initial series of three cards and the fourth and fifth cards all of the same suit and of higher rank than the single dealer card.

18. The method of playing a card game according to claim 15, further including the steps of:
(a) returning the first progressive wager to each player having at least one of the initial series of three cards of the same suit and equaling the rank of the single dealer card;
(b) returning the second progressive wager to each player having the fourth card of the same suit and equaling the rank of the single dealer card; and
(c) returning the second progressive wager to each player having the fifth card of the same suit and equaling the rank of the single dealer card.

19. The method of playing a card game according to claim 15, further including the steps of:
(a) placing at least one poker wager by at least one player;
(b) dealing a fourth card to each player winning their first progressive wagers and placing a second progressive wager, and a fifth card to each player winning their second progressive wagers and placing a third progressive wager;
(c) considering the initial series of three cards along with the fourth card and fifth card as a five-card poker hand;
(d) paying a winning poker wager to the at least one player placing at least one poker wager and having a winning poker hand; and
(e) collecting a losing poker wager by the at least one player placing at least one poker wager and having a losing poker hand.

20. The method of playing a card game according to claim 9, further including the step of using multiple card decks for the play of the card game.
